(19) United States
(12) Patent Application Publication
(10) Pub. No.: US 2024/0195240 A1
(43) Pub. Date: Jun. 13, 2024

(54) ROTOR OF EMBEDDED MAGNET TYPE ROTARY ELECTRIC MACHINE

(71) Applicant: TOYOTA JIDOSHA KABUSHIKI KAISHA, Toyota-shI (JP)

(72) Inventors: Hiroyuki HATTORI, Okazaki-shi (JP); Kenta INUZUKA, Ayase-shi (JP)

(73) Assignee: TOYOTA JIDOSHA KABUSHIKI KAISHA, Toyota-shi (JP)

(21) Appl. No.: 18/473,597

(22) Filed: Sep. 25, 2023

(30) Foreign Application Priority Data
Dec. 7, 2022 (JP) 2022-195969

(51) Int. Cl. H02K 1/276

(52) U.S. Cl. CPC H02K 1/276

(57) ABSTRACT

The rotor includes (a) a cylindrical outer peripheral annular portion centered on the axis, an inner peripheral cylindrical portion provided on the inner peripheral side of the outer peripheral annular portion, and a plurality of connecting portions connecting the outer peripheral annular portion and the inner peripheral cylindrical portion, (b) the outer peripheral annular portion, a plurality of teeth protruding on the inner peripheral side at predetermined angular intervals centered on the axis C is provided, (c) between the plurality of teeth, N poles and S poles in the circumferential direction of the outer peripheral annular portion are arranged so as to alternately face each other, respectively, (d) the connecting portion, a tooth portion sandwiched either between the N poles or between the S poles of the permanent magnets in the circumferential direction, the inner peripheral cylindrical portion is provided only between.

### CROSS-REFERENCE TO RELATED APPLICATION

This application claims priority to Japanese Patent Application No. 2022-195969 filed on Dec. 7, 2022, incorporated herein by reference in its entirety.

### BACKGROUND

### 1. Technical Field

The present disclosure relates to a rotor of an embedded magnet type rotary electric machine.

### 2. Description of Related Art

There is known a rotor of an embedded magnet type rotary electric machine in which a cylindrical outer peripheral portion and an inner peripheral portion provided on an inner peripheral side of the outer peripheral portion are connected by a plurality of connecting portions. For example, such rotors are those described in Japanese Unexamined Patent Application Publication No. 2010-213457 (JP 2010-213457 A).

### SUMMARY

In the rotor of the embedded magnet type rotary electric machine described in JP 2010-213457 A, a magnetic path (a path that is formed of a magnetic material, and through which magnetic flux easily passes) is formed by the inner peripheral portion and the connecting portions. Therefore, a part of the magnetic flux emitted from the north (N) pole of the permanent magnet enters the inner peripheral portion side via the magnetic path, and returns from the inner peripheral portion to the south (S) pole of the permanent magnet via the magnetic path. As a result, the number of magnetic fluxes (the strength of the magnetic field) from the rotor to the stator is reduced. As a result, the performance of the rotary electric machine is deteriorated, for example, the output is decreased.

The present disclosure has been made in view of the above circumstances, and an object thereof is to provide a rotor of an embedded magnet type rotary electric machine which can suppress a decrease in the output of the rotary electric machine by suppressing a decrease in the number of magnetic fluxes from the rotor toward the stator.

The gist of the present disclosure is a rotor of an embedded magnet type rotary electric machine including (a) a magnetic member including a cylindrical outer peripheral portion around an axis, an inner peripheral portion provided on an inner peripheral side of the outer peripheral portion, and a plurality of connecting portions connecting the outer peripheral portion and the inner peripheral portion.

In the rotor, (b) the outer peripheral portion of the magnetic member is provided with a plurality of teeth protruding toward an inner periphery at predetermined angular intervals around the axis, (c) between the teeth of the magnetic member, permanent magnets are arranged such that N poles and S poles alternately face each other in a circumferential direction of the outer peripheral portion, and (d) the connecting portions of the magnetic member are each provided only between the inner peripheral portion and a tooth sandwiched either between the N poles or between the S poles of the permanent magnets in the circumferential direction.

According to the rotor of an embedded magnet type rotary electric machine of the present disclosure, the rotor includes (a) a magnetic member including a cylindrical outer peripheral portion around an axis, an inner peripheral portion provided on an inner peripheral side of the outer peripheral portion, and a plurality of connecting portions connecting the outer peripheral portion and the inner peripheral portion. In the rotor, (b) the outer peripheral portion of the magnetic member is provided with a plurality of teeth protruding toward an inner periphery at predetermined angular intervals around the axis, (c) between the teeth of the magnetic member, permanent magnets are arranged such that N poles and S poles alternately face each other in a circumferential direction of the outer peripheral portion, and (d) the connecting portions of the magnetic member are each provided only between the inner peripheral portion and a tooth sandwiched either between the N poles or between the S poles of the permanent magnets in the circumferential direction. In the magnetic member according to the configuration of (d), since the magnetic path is not formed between the inner peripheral portion and the connecting portions, the reduction in the number of magnetic flux from the rotor toward the stator is suppressed as compared with the case in which the rotor does not include such a magnetic member. Thus, a decrease in the output of the rotary electric machine is suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a radial cross-sectional view of a rotor of an embedded magnet type rotary electric machine according to a first embodiment of the present disclosure;

FIG. 2 is an axial cross-sectional view of the rotor of the embedded magnet type rotary electric machine shown in FIG. 1;

FIG. 3 is a schematic diagram illustrating the flow of the magnetic flux of the rotor shown in FIG. 1;

FIG. 4 is a schematic diagram illustrating a flow of magnetic flux of a rotor according to a comparative example;

FIG. 5 is a radial cross-sectional view of a rotor of an embedded magnet type rotary electric machine according to a second embodiment of the present disclosure; and

FIG. 6 is a cross-sectional view in the axial direction of the rotor of the embedded magnet type rotary electric machine shown in FIG. 5.

### DETAILED DESCRIPTION OF EMBODIMENTS

Hereinafter, embodiments of the present disclosure will be described in detail with reference to the drawings. Note that, in each embodiment, the drawings are simplified or modified as appropriate, and the dimensional ratios, shapes, and the like of the respective portions are not necessarily drawn accurately. Hereinafter, the “direction parallel to the axis C”, “the radial direction of the rotor”, and “the circumferential direction of the rotor” are simply referred to as “the axis C direction”, “the radial direction”, and “the circumferential direction”, respectively.

### Example 1

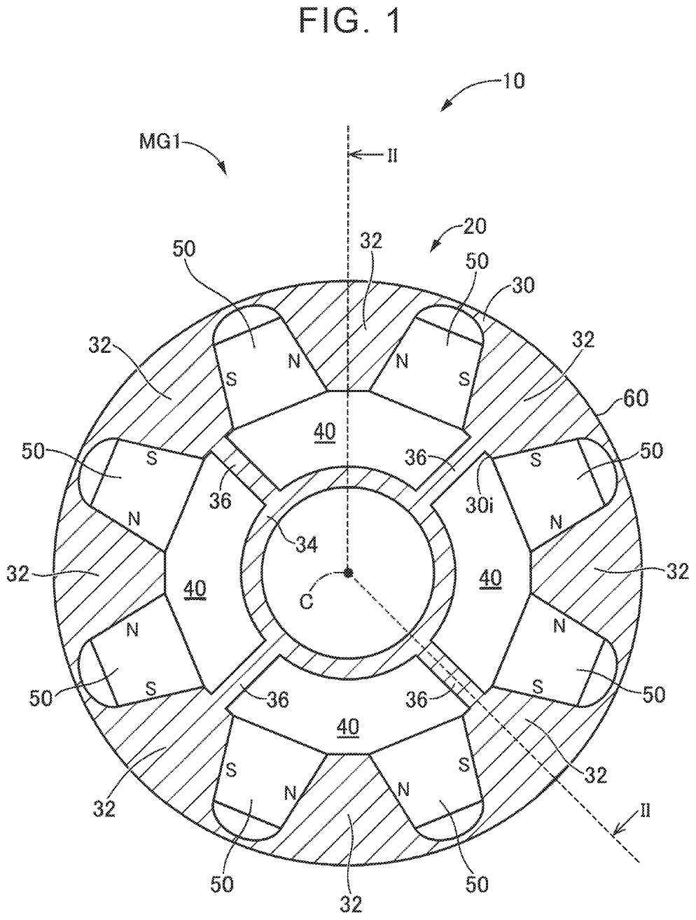

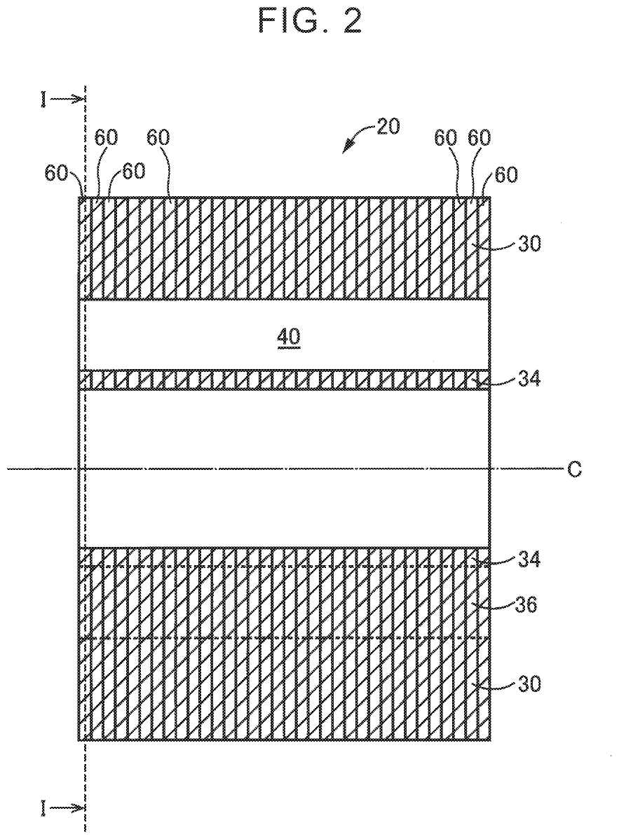

FIG. 1 is a radial cross-sectional view of a rotor 20 of an embedded magnet type rotary electric machine MG1 (hereinafter, simply referred to as a “rotary electric machine MG1”) according to a first embodiment of the present disclosure. FIG. 2 is a cross-sectional view of the rotor 20 of the rotary electric machine MG1 shown in FIG. 1 along an axis C. FIG. 2 is a cross-sectional view taken along a section line II-II shown in FIG. 1. FIG. 1 is a cross-sectional view taken along a I-I of a cutting line shown in FIG. 2.

The rotary electric machine MG1 is a driving power source mounted on the vehicles 10 that are, for example, a hybrid electric vehicle or a battery electric vehicle. The rotary electric machine MG1 is a so-called motor generator that is an embedded magnet type rotary electric machine, and is, for example, a rotary electric machine having a motor function and a generator function. The rotary electric machine MG1 includes a stator including excitation windings (not shown), and a rotor 20 in which permanent magnets 50 are embedded or disposed.

In the rotor 20, a plurality of electromagnetic steel sheets 60 is stacked in the direction of the axis C. The electromagnetic steel sheet 60 is a plate-shaped steel (magnetic material) having high conversion efficiency of electrical energy and magnetic energy. The electromagnetic steel sheet 60 is a plate-like body in which an outer peripheral annular portion 30, an inner peripheral cylindrical portion 34, and a connecting portions 36 are formed, respectively. On the front and back surfaces of the electromagnetic steel sheet 60, an insulating film having a lower permeability than the inside thereof is formed. Note that the electromagnetic steel sheet 60 corresponds to the “magnetic member” and the “plate-like body” in the present disclosure.

The outer peripheral annular portion 30 of the electromagnetic steel sheet 60 has a cylindrical shape centered on the axis C. On the inner peripheral surface 30i of the outer peripheral annular portion 30, a plurality of tooth portions 32 protruding toward the inner peripheral side in the radial direction and extending in the axis C direction is provided at predetermined angular intervals in the circumferential direction (at equal angular intervals of 2π/8 [rad] in the present embodiment). The width of each tooth portion 32 in the circumferential direction is narrower toward the inner peripheral side in the radial direction. Between adjacent tooth portions 32 in the outer peripheral annular portion 30, a plurality of grooves or slots are formed which have a depth in a direction toward the outer peripheral side in the radial direction and penetrate in the axis C direction. Each of the slots has a narrower circumferential width toward the outer peripheral side in the radial direction. The outer peripheral annular portion 30 corresponds to an “outer peripheral portion” in the present disclosure.

The rotor 20 has a permanent magnet 50 arranged and fixed in a slot of the electromagnetic steel sheet 60. For example, the permanent magnet 50 is fixed to each slot by an adhesive. The permanent magnets 50 are arranged such that the N poles and the S poles alternately face each other in the circumferential direction. As a result, in the circumferential direction, the plurality of tooth portions 32 are alternately magnetized between the N poles and the S poles of the permanent magnets 50.

The inner peripheral cylindrical portion 34 of the electromagnetic steel sheet 60 has a cylindrical shape provided on the inner peripheral side of the outer peripheral annular portion 30. The connecting portion 36 is provided between the inner peripheral cylindrical portion 34 and the tooth portion 32 sandwiched between the S poles of the permanent magnets 50 in the circumferential direction among the plurality of tooth portions 32. The connecting portion 36 is not provided between the inner peripheral cylindrical portion 34 and the tooth portion 32 sandwiched between the N poles of the permanent magnets 50 in the circumferential direction among the plurality of tooth portions 32. In this embodiment, the “tooth portion 32 sandwiched between the S poles of the permanent magnets 50 in the circumferential direction” corresponds to the “tooth portion sandwiched either between the N poles or between the S poles of the permanent magnets in the circumferential direction” in the present disclosure. The inner peripheral cylindrical portion 34 corresponds to an “inner peripheral portion” in the present disclosure.

A gap 40 is formed between the inner peripheral surface of the tooth portion 32 sandwiched between the N poles of the permanent magnets 50 in the circumferential direction among the axial C-side surface and the inner peripheral surface 30i of the permanent magnets 50 and the outer peripheral surface of the inner peripheral cylindrical portion 34. For example, in a case where the gap 40 is provided in the rotor 20, the moment of inertia of the rotor 20 is smaller than in a case where the gap 40 is not provided. Thus, the rotational velocity of the rotary electric machine MG1 is changed with good responsiveness.

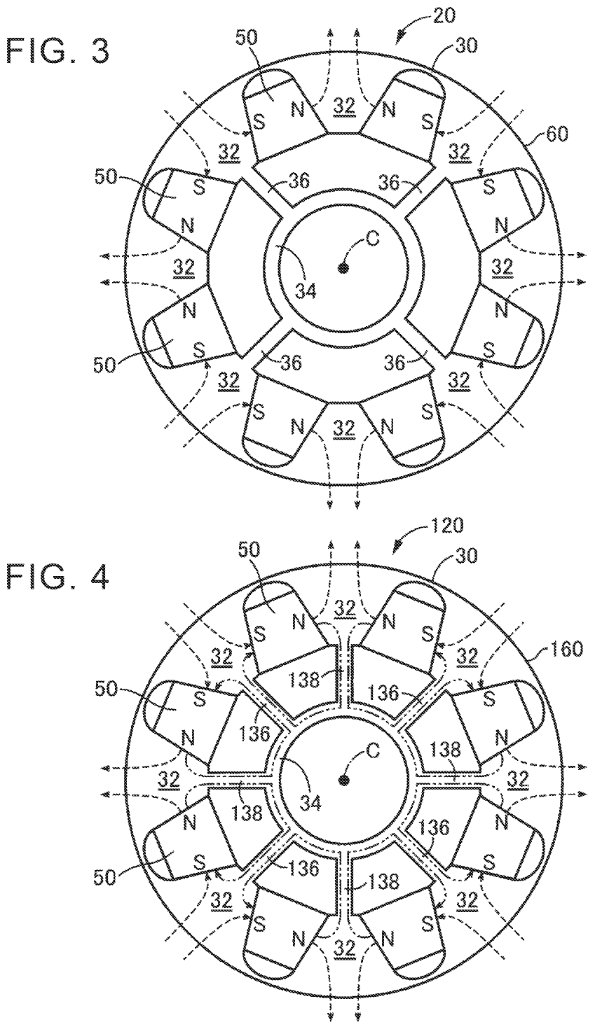

FIG. 3 is a schematic diagram illustrating the flow of the magnetic flux [Wb] of the rotor 20 illustrated in FIG. 1.

As shown in broken lines in FIG. 3, the magnetic flux emitted from the N pole of the permanent magnet 50, after exiting the tooth portion 32 sandwiched between the N poles of the permanent magnets 50 in the circumferential direction, toward the stator (not shown). Magnetic flux toward the stator, after entering the tooth portion 32 sandwiched between the S poles of the permanent magnets 50 in the circumferential direction, returns to the S pole of the permanent magnet 50. The magnetic flux emitted from the N pole of the permanent magnet 50 does not return to the S pole of the permanent magnet 50 via the connecting portion 36 and the inner peripheral cylindrical portion 34 as in the comparative example described later.

FIG. 4 is a schematic view for explaining the flow of the magnetic flux of the rotor 120 of the embedded magnet type rotary electric machine according to the comparative example. The rotor 120 according to the present comparative example has substantially the same configuration as the rotor 20 according to the above-described first embodiment, but is different in that the electromagnetic steel sheet 160 is used instead of the electromagnetic steel sheet 60. In the electromagnetic steel sheet 160, the connecting portion 136 is provided between the inner peripheral cylindrical portion 34 and, of the plurality of tooth portions 32, the tooth portion 32 sandwiched between the S poles of the permanent magnets 50 in the circumferential direction, and the connecting portion 138 is also provided between the inner peripheral cylindrical portion 34 and, of the plurality of tooth portions 32, the tooth portion 32 sandwiched between the N poles of the permanent magnets 50 in the circumferential direction.

In the rotor 120 according to the comparative example, as shown by a broken line in FIG. 4, many of the magnetic flux emitted from the N pole of the permanent magnet 50, after exiting the tooth portion 32 sandwiched between the N poles of the permanent magnets 50 in the circumferential direction, toward the stator (not shown). Magnetic flux toward the stator, after entering the tooth portion 32 sandwiched between the S poles of the permanent magnet 50 in the circumferential direction, returns to the S pole of the permanent magnet 50. Like the two-dot chain line shown in FIG. 4, part of the magnetic flux emitted from the N pole of the permanent magnet 50, the tooth portion 32 sandwiched between the N poles of the permanent magnets 50 in the circumferential direction, the connecting portion 138, the inner peripheral cylindrical portion 34, the connecting portion 136, and the circumferential direction returns to the S pole of the permanent magnet 50 via the magnetic path formed by the tooth portion 32 sandwiched between the S poles of the permanent magnets 50. In the comparative example, as compared with the present embodiment described above, since a part of the magnetic flux emitted from the N pole of the permanent magnet 50 is directed toward the magnetic path described above, the number of magnetic fluxes from the rotor 120 toward the stator (hereinafter, referred to as “effective magnetic flux number”) is reduced.

According to this embodiment, there is provided an electromagnetic steel sheet 60 having (a) a cylindrical outer peripheral annular portion 30 centered on an axis C, an inner peripheral cylindrical portion 34 provided on an inner peripheral side of the outer peripheral annular portion 30, and a plurality of connecting portions 36 connecting the outer peripheral annular portion 30 and the inner peripheral cylindrical portion 34, and (b) a plurality of tooth portions 32 protruding inward at predetermined angular intervals around the axis C is provided on the outer peripheral annular portion 30 of the electromagnetic steel sheet 60, (c) between the plurality of tooth portions 32 of the electromagnetic steel sheet 60, the permanent magnets 50 are arranged such that the N poles and the S poles alternately face each other in the circumferential direction of the outer peripheral annular portion 30, and (d) the connecting portion 36 of the electromagnetic steel sheet 60 is provided only between the inner peripheral cylindrical portion 34 and the tooth portion 32 sandwiched between the S poles of the permanent magnets 50 in the circumferential direction. In the comparative example, the connecting portions 136 and 138 of the electromagnetic steel sheet 160 are provided between both the inner peripheral cylindrical portion 34 and the tooth portions 32 sandwiched between the S poles and between the N poles of the permanent magnets 50 in the circumferential direction. Therefore, a part of the magnetic flux emitted from the N pole of the permanent magnet 50 returns to the S pole of the permanent magnet 50 via the connecting portion 138, the inner peripheral cylindrical portion 34, and the connecting portion 136. On the other hand, in the present embodiment, the magnetic path of the electromagnetic steel sheet 60 according to the configuration (d) is not formed by the connecting portion 36 and the inner peripheral cylindrical portion 34. Therefore, in the present embodiment, as compared with the case where the electromagnetic steel sheet 60 is not provided, the reduction in the number of effective magnetic fluxes from the rotor 20 toward the stator is suppressed, so that the reduction in the power of the rotary electric machine MG1 is suppressed.

According to the present embodiment, (a) the electromagnetic steel sheet 60 is a plate-like body in which the outer peripheral annular portion 30, the inner peripheral cylindrical portion 34, and the connecting portions 36 are formed, an insulating film is formed on the front and back surfaces of the plate-like body. (b) the electromagnetic steel sheet 60 is laminated in the direction of the axis C. By stacking a plurality of electromagnetic steel sheets 60 having the same shape as the plate-like body, a decrease in the number of effective magnetic fluxes from the rotor 20 toward the stator is suppressed, and the generation of eddy currents in the rotor 20 is suppressed.

### Example 2

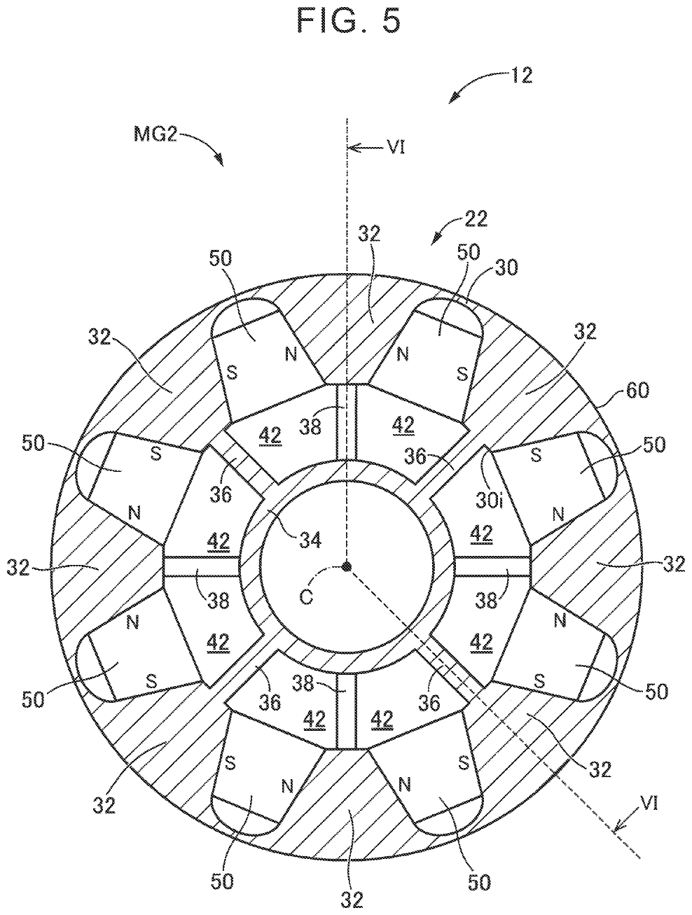

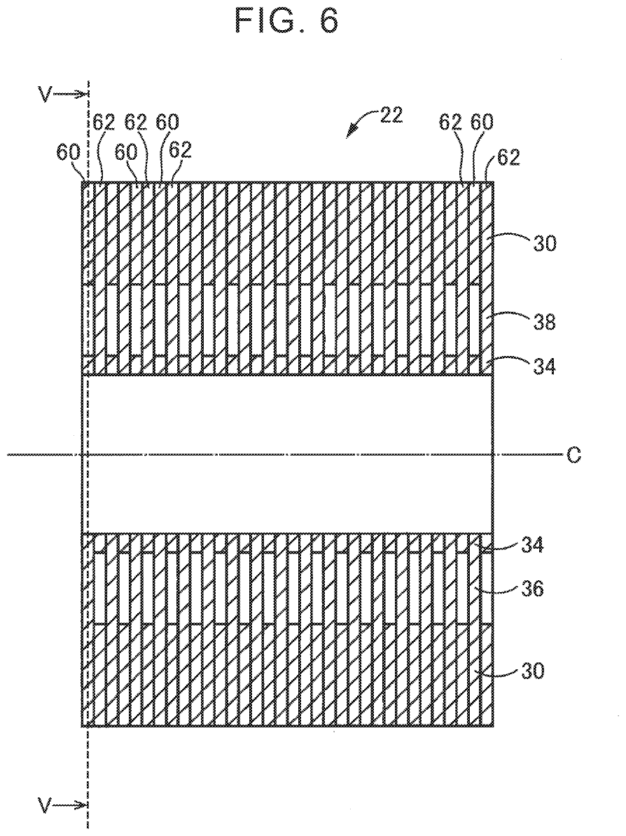

FIG. 5 is a radial cross-sectional view of a rotor 22 of an embedded magnet type rotary electric machine MG2 (hereinafter, simply referred to as a “rotary electric machine MG2”) according to a second embodiment of the present disclosure. FIG. 6 is a cross-sectional view of the rotor 22 shown in FIG. 5 in the direction of the axis C. FIG. 6 is a cross-sectional view taken along a section line VI-VI shown in FIG. 5. FIG. 5 is a cross-sectional view taken along a section line V-V shown in FIG. 6.

The rotary electric machine MG2 is a driving power source mounted on the vehicles 12 that are, for example, a hybrid electric vehicle or a battery electric vehicle. The rotor 22 of the rotary electric machine MG2 is substantially the same as the configuration of the rotor 20 of the rotary electric machine MG1 according to the first embodiment. In Example 1, a plurality of electromagnetic steel sheets 60 was stacked in the direction of the axis C. This embodiment is different from the first embodiment in that a plurality of electromagnetic steel sheets 60 and 62 is alternately stacked in the direction of the axis C. Therefore, a part different from the first embodiment of the present disclosure will be mainly described. In the present embodiment, the same reference numerals are given to portions substantially common to those in the first embodiment and the description thereof will be omitted as appropriate.

The electromagnetic steel sheet 62 has substantially the same configuration as the electromagnetic steel sheet 60. In the electromagnetic steel sheet 60, the connecting portion 36 is provided between the inner peripheral cylindrical portion 34 and the tooth portion 32 sandwiched between the S poles of the permanent magnets 50 in the circumferential direction among the plurality of tooth portions 32. The connecting portion 36 is not provided between the inner peripheral cylindrical portion 34 and the tooth portion 32 sandwiched between the N poles of the permanent magnets 50 in the circumferential direction among the plurality of tooth portions 32. On the other hand, in the electromagnetic steel sheet 62, the connecting portion 38 is provided between the inner peripheral cylindrical portion 34 and the tooth portion 32 sandwiched between the N poles of the permanent magnets 50 in the circumferential direction among the plurality of tooth portions 32. The connecting portion 38 is not provided between the inner peripheral cylindrical portion 34 and the tooth portion 32 sandwiched between the S poles of the permanent magnets 50 in the circumferential direction among the plurality of tooth portions 32. Note that the electromagnetic steel sheet 62 corresponds to the “magnetic member” and the “plate-like body” in the present disclosure. The tooth portions 32 sandwiched between the N poles of the permanent magnets 50 in the circumferential direction of the electromagnetic steel sheet 62 correspond to the “tooth portions sandwiched either between the N poles or between the S poles of the permanent magnets in the circumferential direction” in the present disclosure.

A gap 42 is formed between the surface of the permanent magnet 50 on the axis C side and the outer peripheral surface of the inner peripheral cylindrical portion 34. For example, in a case where the gap 42 is provided in the rotor 22, the moment of inertia of the rotor 22 is smaller than in a case where the gap 42 is not provided. Thus, the rotational velocity of the rotary electric machine MG2 is changed with good responsiveness.

According to this embodiment, (a) an electromagnetic steel sheet 60 having a cylindrical outer peripheral annular portion 30 centered on an axis C, an inner peripheral cylindrical portion 34 provided on an inner peripheral side of the outer peripheral annular portion 30, and a plurality of connecting portions 36 connecting the outer peripheral annular portion 30 and the inner peripheral cylindrical portion 34; An electromagnetic steel sheet 62 having a cylindrical outer peripheral annular portion 30 centered on an axis C, an inner peripheral cylindrical portion 34 provided on an inner peripheral side of the outer peripheral annular portion 30, and a plurality of connecting portions 38 connecting the outer peripheral annular portion 30 and the inner peripheral cylindrical portion 34 is provided, and (b) an outer peripheral annular portion 30 of the electromagnetic steel sheet 60,62 is provided with a plurality of tooth portions 32 respectively protruding to an inner peripheral side at predetermined angular intervals centered on an axis C, (c) between the plurality of tooth portions 32 of the electromagnetic steel sheets 60 and 62, the permanent magnets 50 are arranged such that the N poles and the S poles are arranged so as to alternately face cach other in the circumferential direction of the outer peripheral annular portion 30, and (d) the connecting portion 36 of the electromagnetic steel sheet 60 is provided only between the inner peripheral cylindrical portion 34 and the tooth portion 32 sandwiched between the S poles of the permanent magnets 50 in the circumferential direction, and the connecting portion 38 of the electromagnetic steel sheet 62 is provided only between the inner peripheral cylindrical portion 34 and the tooth portion 32 sandwiched between the N poles of the permanent magnets 50 in the circumferential direction. In the present embodiment, the electromagnetic steel sheets 60 and 62 according to the configuration of (d), the magnetic path can be formed which, for example, leads to the inner peripheral cylindrical portion 34 of the electromagnetic steel sheet 60, the connecting portion 36, and the tooth portion 32 sandwiched between the S poles of the permanent magnets 50 via the tooth portion 32 sandwiched between the N poles of the permanent magnets 50 in the electromagnetic steel sheet 62, the connecting portion 38, and the inner peripheral cylindrical portion 34. However, the magnetic path formed in this embodiment, the magnetic path through the insulating film permeability is lower than the inside of the electromagnetic steel sheets 60 and 62 formed on the front and back surfaces of the electromagnetic steel sheets 60 and 62, and the path is longer than the magnetic path formed in the electromagnetic steel sheet 160 according to the above-described comparative example. Therefore, as compared with the comparative example described above, in this embodiment, the magnetic flux emitted from the N pole of the permanent magnet 50 is less likely to be directed toward the magnetic path. As a consequence, the reduction in the number of effective magnetic fluxes from the rotor 22 to the stator is suppressed, so that the reduction in the power of the rotary electric machine MG2 is suppressed.

According to the present embodiment, (a) the electromagnetic steel sheets 60 and 62 are each a plate-like body formed of the outer peripheral annular portion 30, the inner peripheral cylindrical portion 34, and the connecting portions 36 and 38, respectively, and an insulating film is formed on the front and back surfaces of the plate-like body, (b) the electromagnetic steel sheets 60 and 62 are stacked alternately in the axis C direction. Since the electromagnetic steel sheets 60 and 62 are stacked in a plurality of layers, the number of effective magnetic fluxes from the rotor 22 toward the stator is suppressed from decreasing, and the generation of eddy currents in the rotor 22 is suppressed.

Although the embodiments of the present disclosure have been described in detail with reference to the drawings, the present disclosure is also applied to other aspects.

In the first and second embodiments described above, the inner peripheral cylindrical portion 34 corresponding to the “inner peripheral portion” in the present disclosure has a cylindrical shape, but the present disclosure is not limited thereto and may have a cylindrical shape.

In the first and second embodiments described above, the electromagnetic steel sheets 60 and 62 are each provided with the respective connecting portions 36 and 38 between the inner peripheral cylindrical portion 34 and the tooth portion 32 sandwiched either between the S poles or between the N poles of the permanent magnets 50 alternately in the circumferential direction, but the present disclosure is not limited to this embodiment. For example, the electromagnetic steel sheets 60 and 62 may be configured such that the connecting portions 36 and 38 are provided between the inner peripheral cylindrical portion 34 and the tooth portions 32 sandwiched either between the S poles or between the N poles of the permanent magnets 50 at four or six positions in the circumferential direction.

In the first embodiment described above, the rotor 20 is in a mode in which only the electromagnetic steel sheet 60 is stacked in the direction of the axis C, but the present disclosure is not limited to this mode. For example, the present disclosure may be an electromagnetic steel sheet in which a connecting portion is provided between the inner peripheral cylindrical portion 34 and the tooth portion 32 sandwiched between the N poles of the permanent magnets 50 in the circumferential direction, and a connecting portion is not provided between the inner peripheral cylindrical portion 34 and the tooth portion 32 sandwiched between the S poles of the permanent magnets 50 in the circumferential direction. That is, only the electromagnetic steel sheet 62 in the second embodiment may be stacked in the direction of the axis C.

In the first and second embodiments described above, the rotors 20 and 22 are configured such that at least one of the electromagnetic steel sheet 60 and the electromagnetic steel sheet 62 is stacked in the direction of the axis C, but the present disclosure is not limited to this embodiment. For example, the electromagnetic steel sheet 160 according to the comparative example and at least one of the electromagnetic steel sheet 60 and the electromagnetic steel sheet 62 may be stacked in the direction of the axis C. Even in such a mode, as compared with the case where only the electromagnetic steel sheet 160 is laminated, a decrease in the number of effective magnetic fluxes from the rotor toward the stator is suppressed, and thus a decrease in the output of the rotary electric machine is suppressed.

In the first embodiment described above, the rotor 20 is in a mode in which a plurality of electromagnetic steel sheets 60 which are plate-shaped bodies having the outer peripheral annular portion 30, the inner peripheral cylindrical portion 34, and the connecting portions 36 formed thereon, are stacked in the direction of the axis C. However, the present disclosure may be configured such that the electromagnetic steel sheet 60 is not laminated. For example, the rotor 20 may be configured to include an integral body formed by molding a magnetic powder, a solid, or the like. In this embodiment, the molded magnetic material corresponds to the “magnetic member” in the present disclosure.

In the first and second embodiments described above, the permanent magnets 50 are fixed to the slots of the electromagnetic steel sheets 60 and 62 with an adhesive, but the present disclosure is not limited to this embodiment. For example, a claw-shaped protrusion that suppresses the permanent magnet 50 from moving to the inner peripheral side may be provided at the distal end portion on the inner peripheral side of the tooth portion 32 of the electromagnetic steel sheets 60 and 62, whereby the permanent magnet 50 may be fixed.

In the first and second embodiments described above, the rotors 20 and 22 are provided with the gaps 40 and 42, but the gaps 40 and 42 are not limited to these embodiments. Incidentally, the outer peripheral surface of the inner peripheral cylindrical portion 34, the tooth portion 32 sandwiched between the other of the N poles and S poles of the permanent magnets 50 in the circumferential direction in which the connecting portions 36 and 38 are not provided, at least the gap 40, 42 is provided. In the first and second embodiments described above, the gaps 40 and 42 provided in the rotors 20 and 22 remain as they are, but a filler such as an adhesive having a relative permeability smaller than that of the electromagnetic steel sheets 60 and 62, for example, may be filled. Preferably, the specific gravity of the filler is less than the specific gravity of the electromagnetic steel sheets 60 and 62.

In the first and second embodiments described above, the rotary electric machine MG1, MG2 is a motor generator, but the present disclosure is not limited to this embodiment. For example, the rotary electric machine MG1, MG2 may be a rotary electric machine that does not have a generator function and has only a motor function, or may be a rotary electric machine that does not have a motor function and has only a generator function.

It is to be noted that the above-described embodiments are merely examples of the present disclosure, and the present disclosure can be implemented in various modifications and improvements based on the knowledge of a person skilled in the art without departing from the gist of the present disclosure.

What is claimed is:

1. A rotor of an embedded magnet type rotary electric machine comprising a magnetic member including a cylindrical outer peripheral portion around an axis, an inner peripheral portion provided on an inner peripheral side of the outer peripheral portion, and a plurality of connecting portions connecting the outer peripheral portion and the inner peripheral portion, wherein:
the outer peripheral portion of the magnetic member is provided with a plurality of teeth protruding toward an inner periphery at predetermined angular intervals around the axis;
between the teeth of the magnetic member, permanent magnets are arranged such that N poles and S poles alternately face each other in a circumferential direction of the outer peripheral portion; and
the connecting portions of the magnetic member are each provided only between the inner peripheral portion and a tooth sandwiched either between the N poles or between the S poles of the permanent magnets in the circumferential direction.

2. The rotor according to claim 1, wherein:
the magnetic member is a plate-shaped body including the outer peripheral portion, the inner peripheral portion, and the connecting portions and provided with an insulating film on front and back surfaces of the plate body; and
a plurality of the magnetic members is stacked in an axial direction.
